(19) United States
(12) Patent Application Publication
(10) Pub. No.: US 2017/0046719 A1
(43) Pub. Date: Feb. 16, 2017

(54) SOCIAL MEDIA MOOD PROCESSING FOR CUSTOMER RELATIONSHIP MANAGEMENT (CRM)

(71) Applicant: SugarCRM Inc., Cupertino, CA (US)

(72) Inventors: Vladyslav Kulchytskyy, Nashua, NH (US); Filipe Guerra, San Jose, CA (US)

(21) Appl. No.: 14/825,136

(22) Filed: Aug. 12, 2015

(51) Int. Cl. G06Q 30/00; G06Q 30/02; G06Q 50/00

(52) U.S. Cl. CPC G06Q 30/016; G06Q 50/01; G06Q 30/0201

(57) ABSTRACT

Embodiments of the invention provide a method, system and computer program product for social media mood processing in a customer relationship management (CRM) application. In an embodiment of the invention, a method for social media mood processing in a CRM application includes establishing a communicative connection between a CRM application executing in memory of a host computing system and one or more different feeds of respectively different social media Web sites over a computer communications network. The method also includes monitoring different posts in each of the social media Web sites to detect an association with a specified keyword. Finally, the method includes responding to a detection of a post with the specified keyword, by parsing the detected post to determine if the detected post is negative in nature and if so, identifying an author of the detected post and creating an action in the CRM application for the author.

### BACKGROUND OF THE INVENTION

Field of the Invention

The present invention relates to CRM and more particularly to social media integrated CRM.

Description of the Related Art

CRM refers to the interaction that a business entity enjoys with its customers, whether the business entity provides sales or services to the customer. CRM is often thought of as a business strategy that enables business managers to understand the customer, to retain customers through better customer experience, to attract new customers, increase profitability and to decrease customer management costs. In real terms, however, CRM systems are used specifically to manage business contacts, clients, contract wins and sales leads. As such, CRM solutions provide the end user with the customer business data necessary to provide services or products desired by the customers, to provide better customer service, to cross-sell and to up-sell more effectively, to close deals, retain current customers and understand the identity of the customer.

CRM provides an indispensible tool for product and service providers to manage the customer experience long after the sale has closed. However, the ability to manage all aspects of the customer experience largely depends upon the proactive efforts of the customer who must affirmatively contact the product or service provider with any commentary or concern. Yet, in many cases, an unsatisfied customer will not contact the product or service provider post-sale despite a perceived or actual failure in a purchased product or service. Instead, the customer will either self-support or remain resigned to dissatisfaction. In both instances, the provider of the service or product will remain unaware that a customer has become unhappy.

An unhappy customer, however, is as dangerous to the success of a product or service provider as is a happy customer to generating referral business for the provider. In this regard, a satisfied customer can be relied upon to express his or her satisfaction to a potential new customer. Just the same, a customer who is dissatisfied almost always will express their disappointment to a friend or colleague thus thwarting a future opportunity for a sale. The problem of the unknown dissatisfied customer has become acute in light of social media. More specifically, social media outlets provide a forum for an unhappy customer to express dissatisfaction with a product to a multitude of potential customers in one single posting. Once the unhappy customer presents his or her dissatisfaction on social media, unless the unhappy customer tags the posting in a way so as to alert the product or service provider with the awareness of the posting, the provider will have no way to rectify the dissatisfaction expressed by the unhappy customer.

### BRIEF SUMMARY OF THE INVENTION

Embodiments of the present invention address deficiencies of the art in respect to the integration of social media with CRM and provide a novel and non-obvious method, system and computer program product for social media mood processing in a CRM application. In an embodiment of the invention, a method for social media mood processing in a CRM application includes establishing a communicative connection between a CRM application executing in memory of a host computing system and one or more different feeds of respectively different social media Web sites over a computer communications network. The method also includes monitoring different posts in each of the social media Web sites to detect an association with a specified keyword such as a hashtag. Finally, the method includes responding to a detection of a post with the specified keyword, by parsing the detected post to determine if the detected post is negative in nature and if so, identifying an author of the detected post and creating an action in the CRM application for the author.

In one aspect of the embodiment, the action is created in the CRM application only if the author is determined to be geographically proximate to a designated end user of the CRM application. In another aspect of the embodiment, the post is determined to be negative based upon a presence in the post of keywords present in a table of negativity loaded into memory of the host computing system. In yet another aspect of the embodiment, the post is determined to be negative based upon a presence of an emoticon present in a table of negativity loaded into memory of the host computing system.

In another embodiment of the invention, a CRM data processing system is configured for social media mood processing. The system includes a host computing system that has one or more computers each with memory and at least one processor. The system also includes a CRM application executing the memory of the host computing system. Finally, the system includes a social media mood processing module coupled to the CRM application. The module includes program code enabled to establish a communicative connection between the CRM application and one or more different feeds of respectively different social media Web sites over a computer communications network, to monitor different posts in each of the social media Web sites to detect an association with a specified keyword and to respond to a detection of a post with the specified keyword by parsing the detected post to determine if the detected post is negative in nature and if so, identifying an author of the detected post and creating an action in the CRM application for the author.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for social media mood processing in a CRM application;

FIG. 2 is a schematic illustration of a CRM data processing system configured for social media mood processing; and,

FIG. 3 is a flow chart illustrating a process for social media mood processing in a CRM application.

### DETAILED DESCRIPTION OF THE INVENTION

Embodiments of the invention provide for social media mood processing in a CRM application. In accordance with an embodiment of the invention, a communicative connection is established between a CRM application and one or more different feeds of respectively different social media Web sites. Different posts including an association with a specified product, service or provider of a product or service are processed to identify negative keywords or emoticons present in the posts. For each associated post, a record in the CRM application is compared to the associated post in order to further identify an individual posting the post. Thereafter, if a record exists in the CRM application, a CRM action in connection with the individual is generated in the CRM application to address the associated post. Optionally, a geographic location of either the individual posting the post, or a location at which the posting occurred is determined and compared to a geographic location of an end user of the CRM application and if within a threshold distance of the end user, a CRM action in the CRM application is generated to prompt an in-person meeting between the end user and the individual.

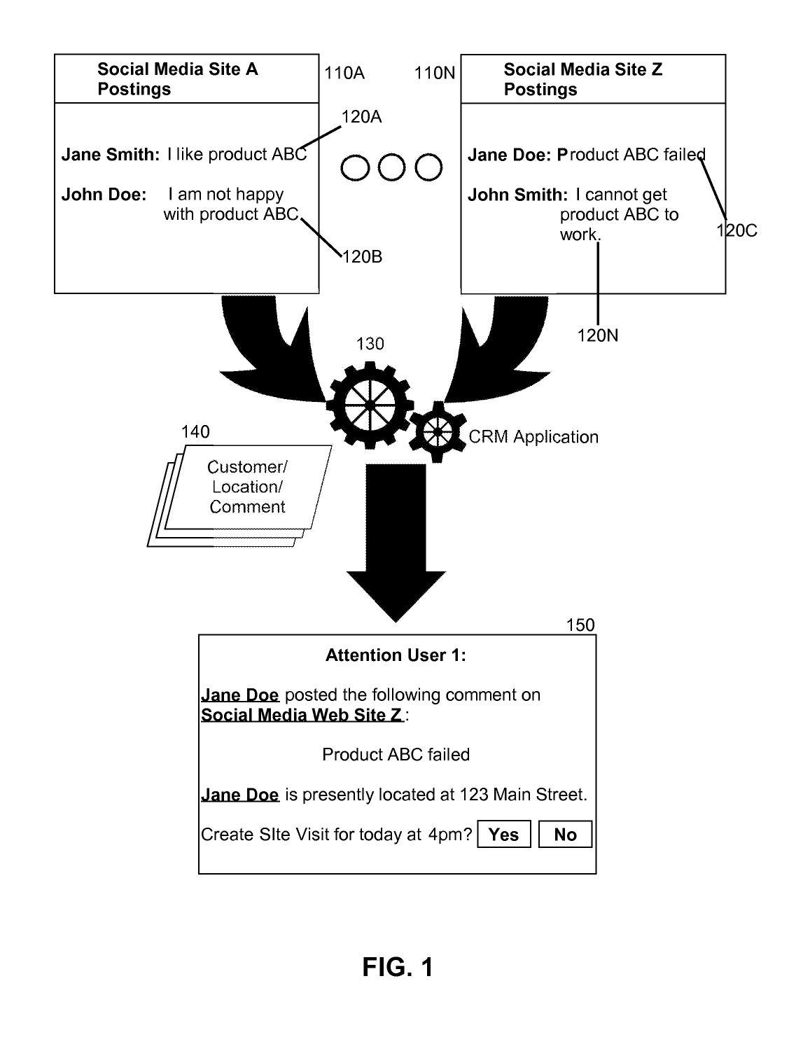

In further illustration, FIG. 1 is a pictorial illustration of a process for social media mood processing in a CRM application. As shown in FIG. 1, a CRM application 130 monitors the postings 120A, 120B, 120C, 120N of different feeds of different social media Web sites 110A, 110N. As postings 120A, 120B, 120C, 120N are presented in the different feeds, the CRM application 130 parses the content of each of the postings 120A, 120B, 120C, 120N in order to identify those of the postings 120A, 120B, 120C, 120N that are provided by customers registered in the CRM application 130 and that are deemed negative in tone. In this regard, the presence of one or more keywords in one or more combinations can be pre-determined by the CRM application 130 as negative in tone.

Thereafter, as the CRM application 130 detects amongst the postings 120A, 120B, 120C, 120N a negative tone, a data structure 140 is created in the CRM application 130 that includes the identity of a corresponding one of the customers of the CRM application 130, a geographic location of the corresponding one of the customers of the CRM application 130 as determined from the one of the postings 120A, 120B, 120C, 120N of the negative tone, and the one of the postings 120A, 120B, 120C, 120N of the negative tone itself. The CRM application 130 then matches the one of the postings 120A, 120B, 120C, 120N of the negative tone to a particular end user of the CRM application 130 known to be geographically proximate to the corresponding one of the customers. Finally, a message 150 is provided to the particular end user of the CRM application 130 prompting the particular end user of the CRM application 130 to create an action in the CRM application 130 in connection with the corresponding one of the customers.

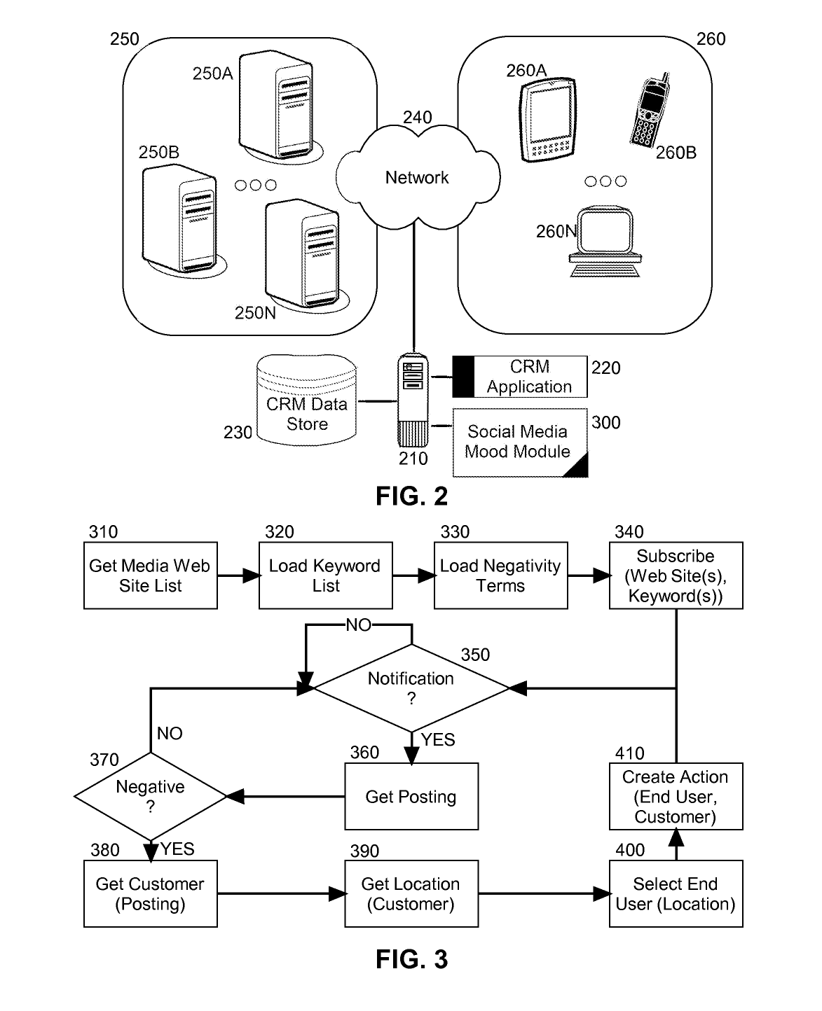

The process described in FIG. 1 is implemented in a data processing system. In further illustration, FIG. 2 schematically shows a CRM data processing system configured for social media mood processing. The system includes a host computing system 210 that includes one or more computers, each with memory and at least one processor. The host computing system 210 supports the operation of a CRM application 220 providing an interface through which different end users create, access, modify and delete CRM data in a CRM data store 230. In this regard, the end users access the CRM application 220 over computer communications network 240 through different end user computing devices 260 including personal computers 260N and mobile devices 260A, 260B such as laptop computers, smart phones and tablet computers.

The host computing system 210 also is communicatively coupled over computer communications network 240 to a selection 250 of different social media Web site servers 250A, 250B, 250N. Each of the different social media Web site servers 250A, 250B, 250N supports the collection and publication of different postings by different individuals in different feeds of different social media Web site servers 250A, 250B, 250N providing different social media Web sites. Importantly, a social media mood module 300 executes in the memory of the host computing system 210 in conjunction with the CRM application 220.

The social media mood module includes computer program code that when executed in the memory of the host computing system, monitors the postings of the different feeds of the different social media Web sites provided by the different social media Web site servers 250A, 250B, 250N. The program code during monitoring identifies postings pertaining to one or more products or services associated with one or more product or service keywords. Of the identified postings, one or more customers registered with the CRM application 220 in the CRM data store 230 are additionally identified. Even further, one or more of the identified postings for customers is analyzed by the program code of the social media mood module 300 by parsing the content of the identified postings to identify one or more keywords pre-determined to be associated with a negative tone. Finally, the program code creates in the CRM data store 230 one or more actions for the CRM application 220 for those of the identified customers, such as scheduling a geographically proximate one of the end users to contact or meet with those of the customers responsible for the postings of negative tone.

In even yet further illustration of the operation of the social media mood module, FIG. 3 is a flow chart illustrating a process for social media mood processing in a CRM application. Beginning in block 310, a list of social media Web sites is loaded along with a list of keywords in block 320 that pertain to one or more products or services. In block 330, one or more negative terms are loaded into memory and in block 340, a subscription for notifications is established in each of the social media Web sites of the social media Web site list for postings including any of the keywords in the keyword list.

In decision block 350, it is determined if a notification for one of the social media Web sites is received. If so, in block 360 the posting associated by the notification is retrieved and processed in memory to determine the tone of the posting based upon the negativity terms. In decision block 370, if it is determined that the posting is negative in tone, in block 380 the customer associated with posting of negative tone is determined and in block 390, a geographic location of the customer is determined based upon location based data retrieved from the social media Web site in which the posting had been posted. Subsequently, in block 400, an end user of the CRM application geographically proximate to the location of the customer is selected. Finally, in block 410 an action is created in the CRM application for the selected end user in connection with the identified customer.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for social media mood processing in a customer relationship management (CRM) application, the method comprising:
establishing a communicative connection between a CRM application executing in memory of a host computing system and one or more different feeds of respectively different social media Web sites over a computer communications network;
monitoring different posts in each of the social media Web sites to detect an association with a specified keyword; and,
responsive to detecting a post with the specified keyword, parsing the detected post to determine if the detected post is negative in nature and if so, identifying an author of the detected post and creating an action in the CRM application for the author.

2. The method of claim 1, wherein the action is created in the CRM application only if the author is determined to be geographically proximate to a designated end user of the CRM application.

3. The method of claim 1, wherein the keyword is a hashtag.

4. The method of claim 1, wherein the post is determined to be negative based upon a presence in the post of keywords present in a table of negativity loaded into memory of the host computing system.

5. The method of claim 1, wherein the post is determined to be negative based upon a presence of an emoticon present in a table of negativity loaded into memory of the host computing system.

6. A customer relationship management (CRM) data processing system configured for social media mood processing, the system comprising:
a host computing system comprising one or more computers each with memory and at least one processor;
a CRM application executing the memory of the host computing system; and,
a social media mood processing module coupled to the CRM application, the module comprising program code enabled to establish a communicative connection between the CRM application and one or more different feeds of respectively different social media Web sites over a computer communications network, to monitor different posts in each of the social media Web sites to detect an association with a specified keyword and to respond to a detection of a post with the specified keyword by parsing the detected post to determine if the detected post is negative in nature and if so, identifying an author of the detected post and creating an action in the CRM application for the author.

7. The system of claim 6, wherein the action is created in the CRM application only if the author is determined to be geographically proximate to a designated end user of the CRM application.

8. The system of claim 6, wherein the keyword is a hashtag.

9. The system of claim 6, wherein the post is determined to be negative based upon a presence in the post of keywords present in a table of negativity loaded into memory of the host computing system.

10. The system of claim 6, wherein the post is determined to be negative based upon a presence of an emoticon present in a table of negativity loaded into memory of the host computing system.

11. A computer program product for social media mood processing, the computer program product comprising a computer readable storage medium having program instructions embodied therewith, the program instructions executable by a device to cause the device to perform a method comprising:
establishing a communicative connection between a customer relationship management (CRM) application executing in memory of a host computing system and one or more different feeds of respectively different social media Web sites over a computer communications network;
monitoring different posts in each of the social media Web sites to detect an association with a specified keyword; and,
responsive to detecting a post with the specified keyword, parsing the detected post to determine if the detected post is negative in nature and if so, identifying an author of the detected post and creating an action in the CRM application for the author.

12. The computer program product of claim 11, wherein the action is created in the CRM application only if the author is determined to be geographically proximate to a designated end user of the CRM application.

13. The computer program product of claim 11, wherein the keyword is a hashtag.

14. The computer program product of claim 11, wherein the post is determined to be negative based upon a presence in the post of keywords present in a table of negativity loaded into memory of the host computing system.

15. The computer program product of claim 11, wherein the post is determined to be negative based upon a presence of an emoticon present in a table of negativity loaded into memory of the host computing system.
